(19) United States
(12) Patent Application Publication
(10) Pub. No.: US 2025/0350007 A1
(43) Pub. Date: Nov. 13, 2025

(54) BATTERY MODULE

(71) Applicant: Robert Bosch GmbH, Stuttgart (DE)

(72) Inventors: Markus Schmitt, Tamm (DE); Ralph Glemser, Brackenheim (DE)

(21) Appl. No.: 19/194,248

(22) Filed: Apr. 30, 2025

(30) Foreign Application Priority Data
May 7, 2024 (DE) 10 2024 204 297.8

(51) Int. Cl. H01M 50/588; H01M 10/653; H01M 50/209; H01M 50/224

(52) U.S. Cl. CPC H01M 50/588; H01M 10/653; H01M 50/209; H01M 50/224

(57) ABSTRACT

A battery module includes a plurality of prismatically configured battery cells (2) which together form a cell stack (4) and which are accommodated in a housing (3) of the battery module (1). An electrical insulation element (7) is arranged at least on a bottom surface (61) of a battery cell (2) between the respective battery cell (2) and the housing (3). The housing has an opening (8) and a thermal balancing material (9) is arranged in the opening (8) between the battery cell (2) and the housing (3).

### BACKGROUND

The invention is based on a battery module.

Provided is a battery module comprising a plurality of individual battery cells, each of which has a positive voltage tap and a negative voltage tap, whereby the respective voltage taps are connected to each other in an electrically conductive manner for an electrically conductive serial and/or parallel connection of the plurality of battery cells to each other and can thus be interconnected to form the battery module. In particular, the battery cells can each have a first voltage tap, in particular a positive voltage tap, and a second voltage tap, in particular a negative voltage tap, which are connected to each other in an electrically conductive manner by means of cell connectors so that an electrically serial and/or parallel connection is formed. Battery modules are themselves in turn interconnected into batteries or entire battery systems.

Due to chemical conversion processes, the interiors of lithium-ion battery cells or lithium polymer battery cells heat up, primarily during rapid energy delivery or absorption in battery systems. The more powerful the battery system is, the greater its heating, thus resulting in the need for an efficient active thermal management system.

In particular, liquid temperature control, e.g. with a mixture of water and glycol, can be used for this purpose. The liquid can be fed through channels arranged in a housing of the battery module or in a cooling plate. The liquid temperature control can be connected to a cooling circuit with other components.

As is well known, the battery cells are cooled via their cell bottom, wherein the heat flow passes through the cell bottom into the housing of the battery module or the cooling plate. A thermal balancing material can be arranged between the cell bottom of the battery cells and the housing or the cooling plate.

The prior art in this regard is, for example, DE 10 2020 201 139 or DE 10 2020 210 202.

### SUMMARY

The advantage of a battery module having the features of the independent claim is a design reliably providing a minimum distance between a battery cell of a plurality of battery cells of the battery module and a housing of the battery module, so that an electrical insulation is ensured. In particular, the thermal resistance and the electrical insulation can be connected in parallel, so that reliable heat dissipation can be formed and ensured despite smaller heat dissipation areas compared to the heat dissipation of pouch cell battery arrangements known from publication DE 10 2010 021 148. A reliable mechanical and thermal connection can be formed.

In accordance with the invention, a battery module is provided for this purpose. The battery module comprises a plurality of prismatically designed battery cells, which together form a cell stack and which are accommodated in a housing of the battery module. An electrical insulation element, which has an opening, is arranged on at least one bottom surface of a battery cell between the respective battery cell and the housing. A thermal balancing material is arranged in the opening between the battery cell and the housing.

At this point, it should be noted that prismatically designed battery cells each comprise a battery cell housing with a total of six lateral surfaces, which are arranged in pairs opposing each other and essentially parallel to each other. In addition, lateral surfaces arranged adjacent one another are arranged perpendicular to one another. The electrochemical components of the respective battery cell are accommodated within the interior of the battery cell housing. Typically, two voltage taps, in particular a positive voltage tap and a negative voltage tap, are arranged on an upper lateral surface, which is referred to as the cover surface. The lower lateral surface opposite the upper lateral surface is referred to as the bottom surface. In this case, the plurality of battery cells can be electrically connected in parallel and/or in series by means of cell connectors.

In contrast to designs known from the prior art, in which an adhesive and/or a thermal balancing material is usually arranged between the plurality of battery cells of the battery module and the housing of the battery module, which comprises thermally conductive particles that are electrically non-conductive, imperfections in the housing of the battery module cannot impair the electrical insulation. The size of the thermally conductive particles is intended to ensure a minimum distance in the known designs, which ensures electrical insulation. However, defects on or in the housing, e.g. due to fire cracks and/or unfavorably selected tolerances, can result in locally smaller distances between the plurality of battery cells and the housing, as a result of which the electrical insulation is not reliably formed and electrical contact may be formed between the plurality of battery cells and the housing. This can lead to leaks in the housing of the respective battery cell and also to failure of the entire battery. Furthermore, force effects on the plurality of battery cells when joining the housing and/or when welding the plurality of cell connectors could be used to locally limit very high surface pressures between the bottom of the battery cell and the housing of the battery module, which ultimately lead to the fact that a minimum distance cannot be guaranteed.

It is advantageous when the plurality of battery cells are arranged with their largest lateral surfaces adjacent to each other in a longitudinal direction of the battery module. In an adjacent arrangement of the battery cells in a longitudinal direction of the battery module, the battery cells are arranged adjacent to one another by way of their respective largest lateral surfaces, which are in particular each arranged perpendicular to the upper lateral surface and to the lower lateral surface. It should at this point be noted that the longitudinal direction of the battery module is in this case accordingly arranged perpendicular to the largest lateral surfaces of the battery cells. This has the particular advantage of allowing the battery module to be designed in a compact way.

Furthermore, spacer elements may also be arranged preferentially between each two battery cells arranged adjacent to one another. It is also possible that end plates may be arranged adjacent to the two battery cells arranged terminally, wherein a spacer element is also arranged preferentially between each of the end plates and the battery cells arranged terminally.

In addition, it is also preferred if the plurality of battery cells are clamped together. In particular, such clamping can be formed by means of tensioning straps. Preferably, the battery module can have two tensioning straps, which are each arranged on one longitudinal side of the cell stack and which are connected to the end plates arranged at the ends. The connection of the tensioning straps to the end plates in this way can preferably be designed to be materially bonded. Furthermore, a further thermal balancing material can be arranged between the tensioning straps and the battery cells of the cell stack, so that the heat distribution between the battery cells can be improved. Overall, a comparatively stable and rigid cell stack can be formed as a result.

It is advantageous if the electrical insulation element is designed as heat-shrink tubing. In particular, ratio between an initial state of the heat-shrink tubing and the shrinkage state of 4:1, 3:1 or 2:1 can be utilized. In particular, a ratio of 2:1 is advantageous. This makes it easy to provide a reliable formation of the electrical insulation element. In particular, the ratio can be adapted to the design of the battery cell in such a way that unimpeded shrinking is possible. The heat-shrink tubing is preferably shrunk by means of heat. This allows a positive-locking connection to be formed between the electrical insulation element in the form of heat-shrink tubing and the battery cell. This can further simplify the handling of the battery cell and the cell stack during assembly due to the positive-locking connection that the electrical insulation element provides to the battery cell in a manner that is secure against loss. In particular, the cell stack can be shifted in the longitudinal and transverse direction of the cell stack without loss of the electrical insulation elements and without damage occurring.

The electrical insulation element and in particular the heat-shrink tubing is preferably chosen such that it has comparatively good sliding properties, a high elongation at break and a high puncture resistance. Furthermore, the heat-shrink tubing can also have additives made of a thermally conductive material. Thanks to its good sliding properties, it is possible for the battery cells and thus also the cell stack to be easily shifted in the housing. Thanks to its high elongation at break, the electrical insulation element can also resist swelling of the respective battery cell. Thanks to its high puncture resistance, the electrical insulation element can resist burn cracks or metallic particles.

Furthermore, the electrical insulation element can also be designed as a deep-drawing film.

It is preferred when the electrical insulation element is partially arranged on the bottom surface of the respective battery cell and partially on all lateral surfaces of the respective battery cell. In particular, this makes it possible for the electrical insulation element and in particular the heat-shrink tubing to enclose all the lower edges of the respective battery cell, thereby forming a reliable arrangement on the respective battery cell so that the edges of the battery cell are covered all around the bottom surface.

In particular, an arrangement on all lateral surfaces also offers the particular advantage that the electrical insulation element is also arranged between two battery cells arranged adjacent to one another and can thus also space them apart.

In this case, it is advantageous if the electrical insulation element has a width and a height. The height is at most 25%, preferably at most 10% and in particular at most 5%, of a height of the battery cell. Furthermore, the width is at most 25%, preferably at most 10% and in particular at most 5%, of a width of the battery cell. This allows for a reliable arrangement and mechanical attachment and also provides sufficient surface area for a thermal connection. In particular, these values can be limited to a minimum value that is still sufficient for a reliable arrangement, so that sufficient surface area is available for a mechanical and/or thermal connection of the battery cell to the housing of the battery module. In particular, the values are chosen such that when the cell connectors are welded for an electrically conductive serial and/or parallel connection of the battery cells, a permissible surface pressure is present due to a counter-holding force. At this point, it should be noted that the width and height of the electrical insulation element can also be referred to as the web width. In the case of heat-shrink tubing, the width and height of the electrical insulation element can be adjusted particularly well by the shrink ratio and the positioning of the heat-shrink tubing on the battery cell.

Preferably, the opening has a rectangular shape.

It is advantageous if the thermal balancing element is designed as a thermally conductive adhesive. In particular, the thermal balancing element or the thermally conductive adhesive is arranged in such a way that the balancing element or the adhesive is arranged exclusively within the opening. This has the particular advantage that the distance between the plurality of battery cells and the housing is determined exclusively by the thickness of the electrical insulation element.

Preferably, the thermally conductive adhesive comprises thermally conductive particles. The electrical insulation can be adjusted particularly advantageously by the thickness of the electrical insulation element, independently of the size of the thermally conductive particles. Furthermore, a possibly required greater thickness of the electrical insulation element can be compensated by selecting the thermal conductivity of the adhesive.

In particular, the thickness of the heat-shrink tubing is chosen so that both reliable heat dissipation from the battery cells and a reliable mechanical connection are ensured over the service life. Furthermore, the thickness is chosen so that a minimal distance is ensured to ensure electrical insulation between the plurality of battery cells and the housing, even if defects occur on the housing.

Preferably, the battery module housing is designed as a die-cast housing, in particular as an aluminum die-cast housing.

It is useful to place an adhesive between the electrical insulation element and the battery cell. This allows a reliable connection to be formed.

Furthermore, it is advantageous if the electrical insulation element is connected to the battery cell in a positive-locking and/or material-locking manner. This allows a reliable connection to be formed.

### BRIEF DESCRIPTION OF THE DRAWINGS

Exemplary embodiments of the invention are shown in the drawings and explained in more detail in the following description.

Shown are:

FIG. 1 shows a perspective view of a cell stack of a battery module according to the invention with electrical insulation elements,

FIG. 2 in a further view from below of the cell stack of the battery module according to the invention with electrical insulation elements as shown in FIG. 1,

FIG. 3 top view of a housing of a battery module according to the invention,

FIG. 4 in a first sectional view of an embodiment of a battery module according to the invention and

FIG. 5 in a second sectional view of an embodiment of a battery module according to the invention.

### DETAILED DESCRIPTION

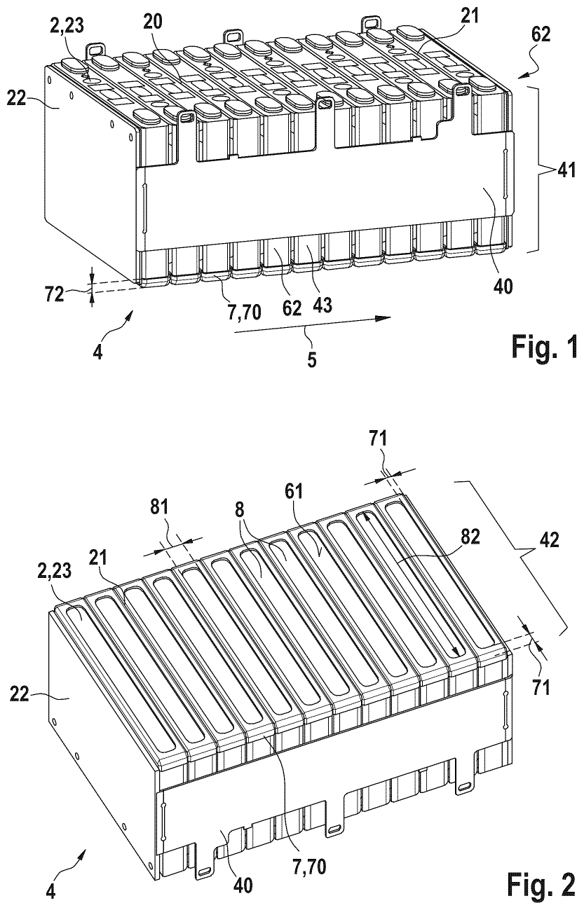

FIG. 1 shows a cell stack 4 of a battery module 1 with electrical insulation elements 7 in a perspective view, and FIG. 2 shows the cell stack 4 of the battery module 1 with electrical insulation elements 7 in a further view from below, according to FIG. 1.

FIGS. 1 and 2 will be described together below.

In FIGS. 1 and 2, a plurality of battery cells 2 can be seen in each case, which are prismatically formed and which together form the cell stack 4. Furthermore, such a cell stack 4 can be received in a housing 3 of the battery module 1, which is not recognizable in FIGS. 1 and 2.

The plurality of battery cells 2 are arranged with their largest lateral surfaces 20 adjacent to one another in a longitudinal direction 5 of the battery module 1.

A spacer element 21 can be arranged between each two neighboring battery cells 2. The battery cells 2 are arranged between two end plates 22, so that a terminal battery cell 23 is arranged adjacent to an end plate 22. The plurality of battery cells 2 are clamped to one another in accordance with the embodiment shown in FIGS. 1 and 2. For this purpose, the battery module 1 can have tensioning straps 40 which are arranged on the longitudinal sides 43 of the cell stack 4 and are connected in a materially bonding manner to the end plates 22.

An electrical insulation element 7 is partially arranged at least on a bottom surface 61 of a battery cell 2 and preferably also on all lateral surfaces 62 of a battery cell 2. The electrical insulation element 7 is preferably designed as heat-shrink tubing 70. The electrical insulation element 7 is ultimately arranged between the battery cells 2 or the cell stack 4 and the housing 3 of the battery module 1.

Furthermore, the electrical insulation elements 7 each comprise an opening 8, in which a thermal balancing material 9, which cannot be seen in FIGS. 1 and 2, is arranged between the battery cell 2 and the housing 3 of the battery module 1. The opening 8 is essentially rectangular.

It can be seen from FIG. 1 that the electrical insulation elements 7 each have a height 72, and it can be seen from FIG. 2 that the electrical insulation elements 7 each have a width 71. It can also be seen that the height 72 is at most 10% of a height 41 of the entire respective battery cell 2 or of the entire cell stack 4. Furthermore, it can be seen that the width 71 is at most 10% of a width 42 of the respective battery cell 2 or of the cell stack 4. In particular, the individual widths 71 of the electrical insulation elements 7 are of uniform width, so that a respective uniform electrical insulation element 7 is formed all around on the bottom surface 61.

This shows that a width 81 of the opening 8 and a length 82 of the opening 8 are large compared to the widths 71 of the respective electrical insulation element 7.

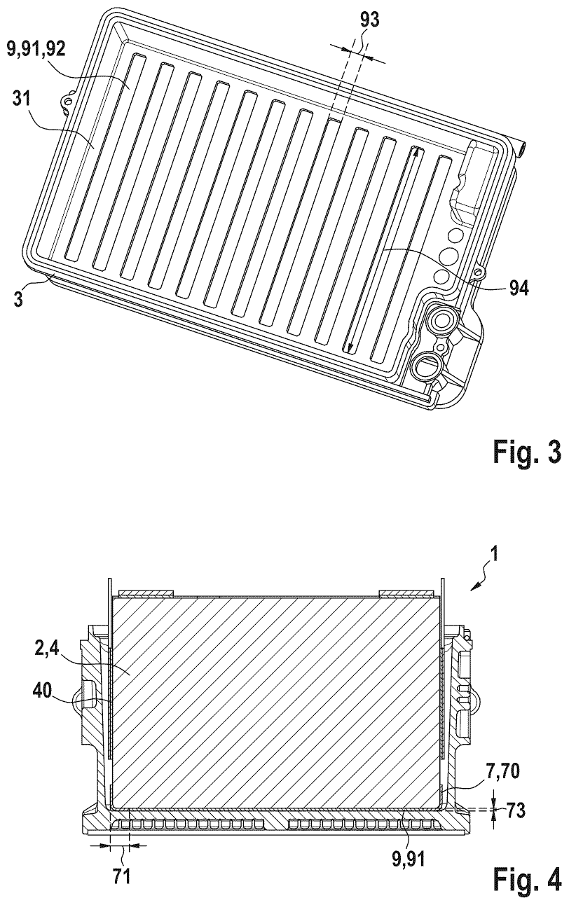

FIG. 3 shows a top view of a housing 3 of a battery module 1 according to the invention. The cell stack 4 can be accommodated in such a housing 3. At this point, it should be noted that in the representation according to FIG. 3, the cell stack 4 is not accommodated in the housing 3.

In particular, a housing base 31 can be seen, which, in an arrangement of the cell stack 4, is arranged directly adjacent to the bottom surface 61 of the respective battery cell 2.

Furthermore, FIG. 3 shows the application of a thermal balancing element 9. This thermal balancing element 9 is designed as a thermally conductive adhesive 91.

The adhesive 91 is applied in the form of adhesive beads 92. These adhesive beads 92 have a length 93 and a width 94. The length 93 and the width 94 of the adhesive beads 92 are selected such that, after the cell stack 4 has been arranged in the housing 3, the thermally conductive adhesive 91 does not come into contact with the electrical insulation elements 7.

Furthermore, the thermal balancing element 9 or the thermally conductive adhesive 91 can be arranged over a large area between the battery cells 2 or the cell stack 4 and the housing 3.

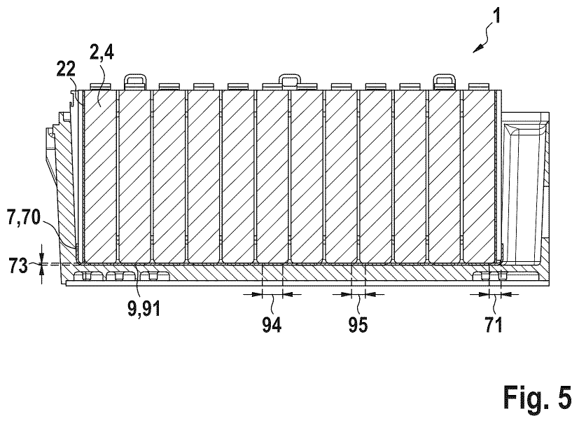

FIG. 4 shows an embodiment of a battery module 1 according to the invention in a first sectional view and FIG. 5 shows an embodiment of a battery module 1 according to the invention in a second sectional view.

FIGS. 4 and 5 are described together below.

First, the cell stack 4 with the prismatically designed battery cells 2 can be seen. Furthermore, the end plates 22 and the tensioning straps 40 can be seen.

Moreover, the electrical insulation elements 7, which are each designed as heat-shrink tubing 70, can be seen in FIGS. 4 and 5. The thickness 73 of the electrical insulation element 7 can also be seen in FIGS. 4 and 5. In addition, the width 71 of the electrical insulation element 7 can also be seen in FIGS. 4 and 5.

FIG. 5 also shows the width 94 of the adhesive beads 92, which are spaced apart from one another by a distance 95.

1. A battery module comprising a plurality of prismatically configured battery cells (2) which together form a cell stack (4) and which are accommodated in a housing (3) of the battery module (1), wherein an electrical insulation element (7) is arranged at least on a bottom surface (61) of a battery cell (2) between the respective battery cell (2) and the housing (3), which housing has an opening (8), wherein a thermal balancing material (9) is arranged in the opening (8) between the battery cell (2) and the housing (3).

2. The battery module according to claim 1, wherein the plurality of battery cells (2) are arranged adjacent to one another with respective largest lateral surfaces (20) in a longitudinal direction (5) of the battery module (1).

3. The battery module according to claim 1, wherein the electrical insulation element (7) is configured as heat-shrink tubing (70).

4. The battery module according to claim 1, wherein the electrical insulation element (7) is arranged partly on the bottom surface (61) of the respective battery cell (2) and partly on all lateral surfaces (62) of the respective battery cell (2).

5. The battery module according to claim 4, wherein the electrical insulation element (7) has a width (71) and a height (72), wherein the height (71) is at most 25% of a height (41) of the battery cell (2) and/or the width (71) is at most 25% of a width (42) of the battery cell (2).

6. The battery module according to claim 1, wherein the thermal balancing element (9) is configured as a thermally conductive adhesive (91).

7. The battery module according to claim 1, wherein the housing (3) is configured as a die-cast housing (31).

8. The battery module according to claim 1, wherein an adhesive is arranged between the electrical insulation element (7) and the battery cell (2).

9. The battery module according to claim 1, wherein the electrical insulation element (7) is connected to the battery cell (2) in a positive-locking and/or material-locking manner.

10. The battery module according to claim 2, wherein the plurality of battery cells (2) are clamped together.

11. The battery module according to claim 7, wherein the housing (3) is configured as an aluminum die-cast housing (32).
